(19) United States
(12) Patent Application Publication
(10) Pub. No.: US 2022/0172600 A1
(43) Pub. Date: Jun. 2, 2022

(54) CONTROL UNIT FOR A HAZARD ALERT CENTER, HAZARD ALERT SYSTEM AND METHOD FOR OPERATING A HAZARD ALERT CENTER

(71) Applicant: Minimax Viking Research & Development GmbH, Bad Oldesloe (DE)

(72) Inventors: Frieder KLOTZ, Bad Oldesloe (DE); Sabine HIPP, Bad Oldesloe (DE)

(21) Appl. No.: 17/600,542

(22) PCT Filed: Mar. 26, 2020
(86) PCT No.: PCT/EP2020/058481

§ 371 Date: Sep. 30, 2021

(30) Foreign Application Priority Data
Apr. 12, 2019 (DE) 10 2019 109 744.4

(51) Int. Cl. G08B 25/12; G08B 17/00

(52) U.S. Cl. CPC G08B 25/12; G06F 3/0488; G08B 17/00

(57) ABSTRACT

The invention relates to a control unit for a hazard alert center, for example a break-in, fire alarm and/or fire extinguisher control center, to a hazard alert system, preferably a fire alarm system, and to a method for operating a hazard alert center, for example a break-in, fire alarm and/or fire extinguisher control center. In particular, the invention relates to a control unit for a hazard alert center, for example a break-in, fire alarm and/or fire extinguisher control center, the control unit being designed to receive, from a hazard detector for detecting a hazardous situation, a first signal characterizing the hazardous situation, and the control unit comprising a user interface having a display means, which is designed to show a standard display and/or an alert display, in the case of which an oldest alert and a latest alert are displayed and additional alerts between the oldest alert and the latest alert can be displayed, preferably scrollably, and a first event display, which shows a first event in a main portion.

### PRIORITY CLAIM AND INCORPORATION BY REFERENCE

This application is a 35 U.S.C. § 371 application of International Application No. PCT/EP2020/058481, filed Mar. 26, 2020, which claims the benefit of German Application No. 10 2019 109 744.4 filed Apr. 12, 2019, each of which is incorporated by reference in its entirety.

### TECHNICAL FIELD

The present invention relates to a control unit for a hazard alert center, for example a break-in, fire detector and/or extinguishing control center, to a hazard alert system, preferably a fire detector system, and to a method for operating a hazard alert center, for example a break-in, fire detector and/or extinguishing control center.

### BACKGROUND AND SUMMARY OF THE INVENTION

Hazard alert systems, in particular fire detector systems, are fundamentally known. Hazard alert systems generally have a hazard detector and a signal-processing control unit. The hazard detector may be, for example, a fire detector. Hazard detectors are used, in particular, to detect hazard characteristic variables, for example toxic gases, combustion gases, flames and sparks.

Control units are generally provided in hazard alert centers, for example break-in, fire detector and/or extinguishing control centers. Hazard alert centers usually have a display and operating component. On such a display and operating component, it is possible to carry out configurations, for example, and/or to assign faults or alarms to an associated hazard detector.

Since a hazard alert center is a safety-relevant component of the hazard alert system, the assignment of faults or alarms to an associated hazard detector, as mentioned above, should be carried out quickly. However, current hazard alert centers are often distinguished by the fact that the detection of faults or alarms and also the assignment of the latter to associated hazard detectors are time-consuming.

In addition, the displays may be unclear, with the result that it is difficult for a user to grasp a fast and reliable assignment of the message. The messages are usually signaled in the form of a list. However, the fast detection and assignment of a fault or a hazard, in particular, are highly important in the safety-related field of hazard alert systems, in which case short response times are also required.

The German Patent and Trademark Office searched the following prior art in the priority application for the present application: U.S. Pat. No. 5,297,252 A and US 2016/0300460 A1.

Against this background, an object of the present invention is to provide a control unit for a hazard alert center, for example a break-in, fire detector and/or extinguishing control center, a hazard alert system, preferably a fire detector system, and a method for operating a hazard alert center, for example a break-in, fire detector and/or extinguishing control center, which reduce or eliminate one or more of the disadvantages mentioned. An object of the invention is also to provide a solution which makes it possible for an operator of a hazard alert system to grasp an alarm and/or a fault more quickly.

According to a first aspect of the invention, the object mentioned at the outset is achieved by means of a control unit for a hazard alert center, for example a break-in, fire detector and/or extinguishing control center, wherein the control unit is configured to receive, from a hazard detector for detecting a hazardous situation, a first signal characterizing the hazardous situation, comprises a user interface having a display means which is configured to present a standard display and/or a message display, wherein an oldest message and a latest message are displayed and further messages can be displayed between the oldest message and the latest message, preferably can be displayed in a scrollable manner, and a first event display which displays a first event in a main section, wherein the oldest message and the latest message are displayed in a first edge section, and is configured, upon receiving the first signal, to control the display means in such a manner that the first event display is displayed instead of the standard display and/or the message display.

The hazard detector is designed to detect a hazardous situation. The hazard detector may be, for example, a fire detector which is preferably in the form of a smoke detector or a flame detector.

The hazard detector which does not belong, in particular, to the control unit is preferably designed to generate a first signal characterizing the hazardous situation. The control unit is accordingly configured to receive the first signal. The control unit may comprise suitable receiving means for this purpose.

The control unit comprises the user interface having the display means. The display means can be used to present the standard display and/or the message display as well as the first event display. The standard display may be, for example, a screensaver. The control unit may be configured to display the standard display if there has been no user interaction for a predetermined time. In addition, the control unit may be configured to display the standard display if the first event display has been displayed for a predetermined time, for example 1 hour.

The message display may display a plurality of individual messages. The content of a message may be, for example, a fault, a fire or a fire pre-alarm. The control unit is configured in such a manner that an oldest message and a latest message are always displayed. In addition, it is possible to display further messages which are displayed, for example, between the oldest message and the latest message. The control unit is preferably also configured in such a manner that the display of the further messages can be changed, for example by scrolling, and a multiplicity of further messages can therefore be displayed between the latest message and the oldest message. The messages are preferably arranged chronologically from the oldest message, which is arranged in an upper region for example, to the latest message, which is arranged in a lower region, for example.

If a hazard detector detects a hazardous situation, it preferably generates the first signal characterizing the hazardous situation. The control unit is configured in such a manner that the first event display is displayed when the first signal is received. The first event display displays the first event in the main section, with the result that a user of the control unit can immediately see the first event. The first event may be, for example, a fire in a monitoring region monitored by the hazard detector.

As soon as the first event display is presented by the display means, the oldest message and the latest message are displayed in a first edge section. The first edge section differs from the main section. The edge section is characterized, in particular, by the fact that it occupies a smaller part of the display area of the display means than the main section.

The edge section may be arranged in an edge region of the display means. For example, the first edge section may be arranged on the left, on the right, at the top or at the bottom. The first event display therefore comprises the presentation of the first event and of the oldest and latest message.

A blocking time may be provided for the presentation of the first event display in the main section. The first event display remains during the blocking time and a standard display or a message display is not presented. The blocking time may be 1 hour, for example.

The invention is based on the knowledge that a fast grasp of a hazard message by a user of a control unit of a hazard alert center may be important for the efficiency of a hazard alert system. In particular, the fast grasp of a hazardous situation may increase the speed of the user's response and may therefore reduce or avoid personal injury and/or material damage. For example, the user can more quickly decide to alert the fire department, for example by actuating the first action means explained in more detail below.

According to one preferred embodiment variant of the control unit, provision is made for the user interface to be in the form of a touch-sensitive input and output screen.

The touch-sensitive input and output screen may be in the form of a so-called touchscreen, for example. Such screens have the advantage that the control unit does not have any buttons or has fewer buttons which are possibly susceptible to wear. The output screen should be understood as meaning an output means. The input screen can be designed to overlap the output screen. A touch-sensitive input and output screen is also space-saving.

A further preferred embodiment variant of the control unit comprises a message actuation means, wherein, when the message actuation means is actuated, the display means is controlled by the control unit in such a manner that the message display is displayed instead of the first event display, wherein the message actuation means is preferably arranged on the input and output screen, preferably in the main section.

The message actuation means may be formed, for example, by the touch-sensitive input and output screen. By actuating the message actuation means, a user of the control unit can reach the message display from the first event display. As a result, the user can reach the message display having detailed information from the first event display which is intuitive, in particular, but preferably has a low information density.

One preferred development of the control unit provides for the latter to comprise a first action means, wherein the control unit is configured to generate and preferably transmit an alarm signal, in particular for alerting a fire department, when the first action means is actuated, and/or a second action means, wherein the control unit is configured to extend a predetermined waiting time by a predetermined investigation time when the second action means is actuated, and/or a third action means, wherein the control unit is configured to prevent an alarm signal from being generated and/or transmitted when the third action means is actuated.

The action means may be arranged, for example, as touch-sensitive and/or pressure-sensitive buttons on the user interface. They may be part of the touch-sensitive input and output screen, for example. The predetermined waiting time may be, for example, the time which is intended to elapse between the receipt of the first signal in the control unit and the transmission of an alarm signal, for example for alerting a fire department. If there is no interaction in this time, the alarm signal is transmitted and the first event display is still presented.

If a user acts with the control unit during the waiting time, the user can actuate the first action means, the second action means or the third action means. If the user actuates the second action means, the waiting time is extended by the predetermined investigation time. The predetermined investigation time can be used by the user, for example, to verify the hazardous situation, for example by the user reaching the corresponding hazard detector and assessing the hazardous situation. The waiting time may be 30 seconds, for example. The waiting time and the predetermined investigation time together may be at most 10 minutes, for example.

If the user reaches the control unit before expiry of the waiting time and is of the opinion that an alarm signal needs to be generated, the user can immediately actuate the first action means, with the result that the alarm signal is transmitted. In addition, the user can also actuate the third action means by preventing an alarm signal from being generated and/or transmitted.

In a further preferred development of the control unit, provision is made for the first action means, the second action means and/or the third action means to be arranged on the input and output screen, preferably in a second edge section.

The first edge section preferably differs from the second edge section. The first edge section may be formed, for example, in a lower region as a row. The second edge section may be presented, for example, as a column in a left-hand section of the display means. In particular, it is preferred for the first edge section and the second edge section to not overlap, with the result that there is a clear assignment of the action means to the function to be controlled with the latter.

It is also preferred for the control unit to be configured to generate and preferably transmit the alarm signal, in particular for alerting a fire department, after a predetermined waiting time after receiving the first signal, and for the control unit to preferably be configured to present an alarm signal display on the display means. The alarm signal display is used to express to a user of the control unit that the fire department has already been called.

According to a further preferred embodiment of the control unit, the latter is configured to receive an all-clear signal and, upon receiving the all-clear signal, to control the display means in such a manner that the standard display and/or the message display is/are displayed instead of the event display.

The all-clear signal can be used for acknowledgement and/or resetting, in particular.

According to a further preferred embodiment variant of the control unit, provision is made for the display means to be configured to present a second event display, which displays a second event in the main section, and/or to present a third event display, which displays a third event in the main section, wherein the oldest message and the latest message are displayed in the first edge section, and the control unit is configured to receive and/or generate a second signal characterizing a fault, in particular a fault signal, and, upon receiving the second signal, to control the display means in such a manner that the second event display is displayed instead of the standard display and/or the message display, and/or to receive and/or generate a third signal characterizing an alarm, in particular an alarm signal, and, upon receiving the third signal, to control the display means in such a manner that the third event display is displayed instead of the standard display and/or the message display.

The second event may be a fault, for example. If the second event is displayed in the main section, the oldest message the latest message are displayed in the first edge section. The third event may be an alarm. If the third event is displayed in the main section, the latest and the oldest message can be displayed in a similar manner to the first or second event display.

Alternatively, only the latest message can also be displayed as the only message in the first edge section in the first, second and/or third event display.

As soon as there is a fault and the control unit receives or generates the second signal, the display means is controlled in such a manner that the second event display is displayed. In a similar manner to this, in the event of an alarm, the third signal is generated or received and, upon reception of the third signal, the display means is controlled in such a manner that the third event display is displayed.

In a further preferred embodiment variant, provision is made for the oldest message and/or the latest message and/or the further messages to have a bar-shaped presentation, wherein the bar-shaped presentation preferably extends from a left-hand edge of the display means to a right-hand edge of the display means.

In addition, it may be preferred for the display means to have a display region and for the main section to occupy more than 60%, more than 70%, more than 80% or more than 90% of the size of the display region.

Furthermore, the first edge section may be arranged in a lower section of the display region and may preferably adjoin a lower edge of the display region and may preferably occupy less than 30%, less than 20% or less than 10% of a height of the display region. Furthermore, it is preferred for the second edge section to be arranged in a left-hand section of the display region and to preferably adjoin a left-hand edge of the display region and to preferably occupy less than 30%, less than 20%, less than 10% or less than 5% of a width of the display region.

In addition, it is preferred for the control unit to be configured to display the standard display on the display means after a predefined inactivity time. The inactivity time may be, for example, 1 hour in the case of a fire alarm.

According to a further aspect, the object mentioned at the outset is achieved by means of a hazard alert center, for example a break-in, fire detector and/or extinguishing control center, comprising a control unit according to one of the embodiment variants described above.

According to a further aspect, the object mentioned at the outset is achieved by means of a hazard alert system, preferably a fire detector system, having a hazard alert center, for example a break-in, fire detector and/or extinguishing control center, the hazard alert system comprising a hazard detector for detecting a hazardous situation, for example a fire, a control unit which is coupled to the hazard detector using signaling and is configured to receive a first signal characterizing the hazardous situation from the hazard detector, wherein the control unit comprises a user interface having a display means, wherein the display means is configured to present a standard display and/or a message display, wherein an oldest message and a latest message are displayed and further messages can be displayed between the oldest message and the latest message, preferably can be displayed in a scrollable manner, a first event display which displays a first event in a main section, wherein the oldest message and the latest message are displayed in a first edge section, wherein the control unit is configured, upon receiving the first signal, to control the display means in such a manner that the first event display is displayed instead of the standard display and/or the message display.

According to a further aspect, the object mentioned at the outset is achieved by means of a method for operating a hazard alert center, for example a break-in, fire detector and/or extinguishing control center, comprising the steps of: displaying a standard display and/or a message display by means of a display means, wherein an oldest message and a latest message are displayed and further messages can be displayed between the oldest message and the latest message, preferably can be displayed in a scrollable manner; detecting a hazardous situation and generating a first signal characterizing the hazardous situation; receiving the first signal; and displaying a first event in a first main section of the display means and the oldest message and the latest message in a first edge section.

The method and its possible developments have features and method steps which make them suitable, in particular, for use for a control unit, a hazard alert center and a hazard alert system and their respective developments. For further advantages, embodiment variants and embodiment details of these further aspects and their possible developments, reference is also made to the above description of the corresponding features and developments of the control unit.

### BRIEF DESCRIPTION OF THE DRAWINGS

Preferred exemplary embodiments are explained, by way of example, on the basis of the accompanying figures, in which

FIG. 1 shows a schematic illustration of a hazard alert system;

FIG. 2 shows the hazard alert system from FIG. 1 with a first event display;

FIG. 3 shows the hazard alert system from FIG. 1 with a second event display;

FIG. 4 shows the hazard alert system from FIG. 1 with a third event display;

FIG. 5 shows the hazard alert system from FIG. 1 with a message presentation; and

FIG. 6 shows a schematic method for operating a hazard alert center.

### MODE(S) FOR CARRYING OUT THE INVENTION

In the figures, identical or substantially functionally identical or similar elements are denoted using the same reference signs.

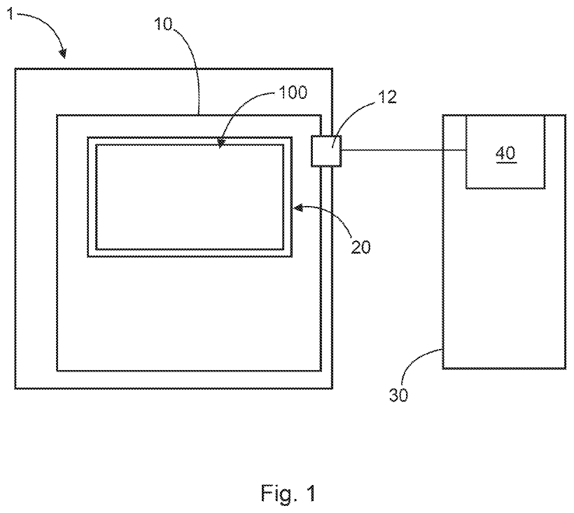

FIG. 1 shows a schematic illustration of a hazard alert system. The hazard alert system comprises a hazard alert center 1 having a control unit 10 and a hazard detector 40. The hazard detector 40 may be, for example, a combustion gas or smoke gas detector, a heat detector, a smoke detector, a flame detector or a spark detector. The hazard detector 40 is arranged in a monitoring region 30. The monitoring region 30 is preferably locally separate from the location at which the control unit 10 is arranged.

The control unit 10 is part of the hazard alert center 1 which is preferably in the form of a break-in, fire detector and/or extinguishing control center. The control unit 10 comprises a display means 20. The display means 20 is designed to display information. The display means 20 may be in the form of a touch-sensitive input and output screen, for example.

The display means 20 may present a wide variety of information, for example the standard display 100 shown in FIG. 1. The standard display 100 may be a screensaver, for example. In particular, the standard display 100 is displayed by the display means 20 if there has been no interaction with an operator of the hazard alert center 1 and/or the control unit 10 for a predetermined period.

The hazard detector 40 is designed to detect a hazardous situation. The control unit is configured to receive a first signal characterizing the hazardous situation from the hazard detector 40. For this purpose, the hazard alert system has a coupling interface 12. The coupling interface 12 couples the hazard detector 40 to the control unit 10.

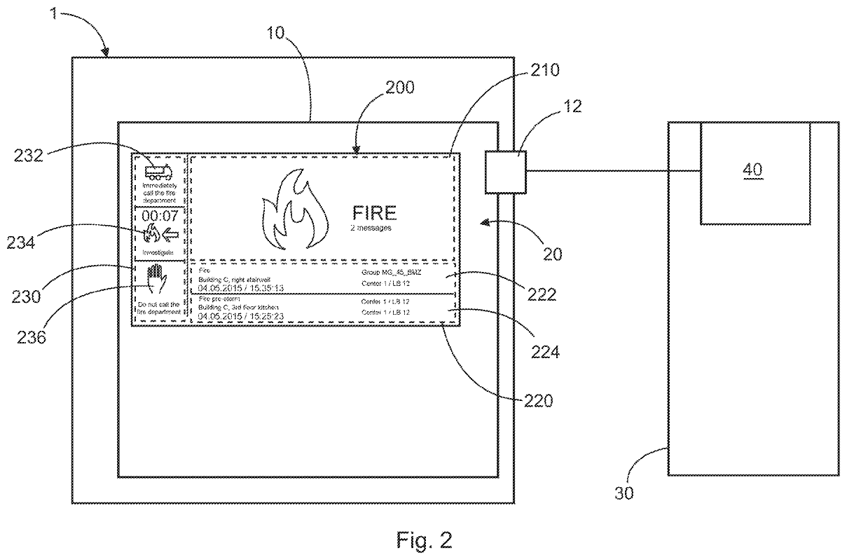

FIG. 2 shows the hazard alert system from FIG. 1 with a first event display 200. In this state shown here, the hazard detector 40 detected a hazardous situation and a first signal characterizing this hazardous situation was received by the control unit 10. The control unit 10 is configured, upon receiving this first signal, to control the display means 20 in such a manner that the first event display 200 is displayed instead of the standard display 100. The same applies if the message display explained in yet more detail below is displayed on the display means 20. The first event display 200 displays a first event in a main section 210. The first event display also displays an oldest message 222 and a latest message 224 in a first edge section 220.

The main section 210 is preferably the largest region displayed on the display means 20. The first edge section 220 is arranged in a region which adjoins a lower edge and a right-hand edge of the display means 20.

The first event display 200 also comprises a second edge section 230. The second edge section 230 is arranged adjacent to a left-hand edge of the display means 20. The second edge section 230 comprises a first action means 232, a second action means 234 and a third action means 236. When the first action means 232 is actuated, an alarm signal is generated and transmitted, wherein the alarm signal can be designed to alert a fire department. When the second action means 234 is actuated by an operator, a predetermined waiting time is extended by a predetermined investigation time. The waiting time is, for example, the time which elapses between the receipt of the first signal at the control unit 10 and the transmission of an alarm signal, for example to a fire department. This time may be 30 seconds, for example. The predetermined investigation time then extends this waiting time so that an operator, for example, can verify the detected hazardous situation.

The third action means 236 preferably prevents an alarm signal from being generated and/or transmitted. The third action means can be used, for example, by an operator in the event of a false alarm in order to prevent a fire department from being alerted.

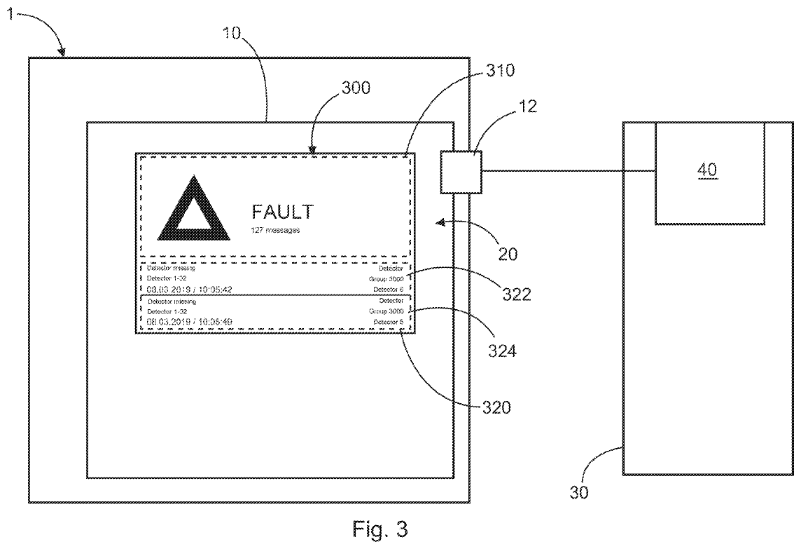

FIG. 3 shows the hazard alert system from FIG. 1 with a second event display 300. The hazard alert system shown comprises the hazard alert center 1 having a control unit 10 and a coupling interface 12, wherein the coupling interface 12 couples the control unit 10 to the hazard detector 40, wherein the hazard detector 40 can monitor the monitoring region 30 and can detect hazardous situations.

A second event display 300 is shown on the display means 20 of the control unit 10. The second event display 300 likewise comprises a main section 310 and a first edge section 320, but no second edge section described above. The display means 20 here shows a second event display 300 which displays a second event the main section 310 and a latest message 324 and an oldest message 322 in the first edge section 320. In the present case, the second event is a fault.

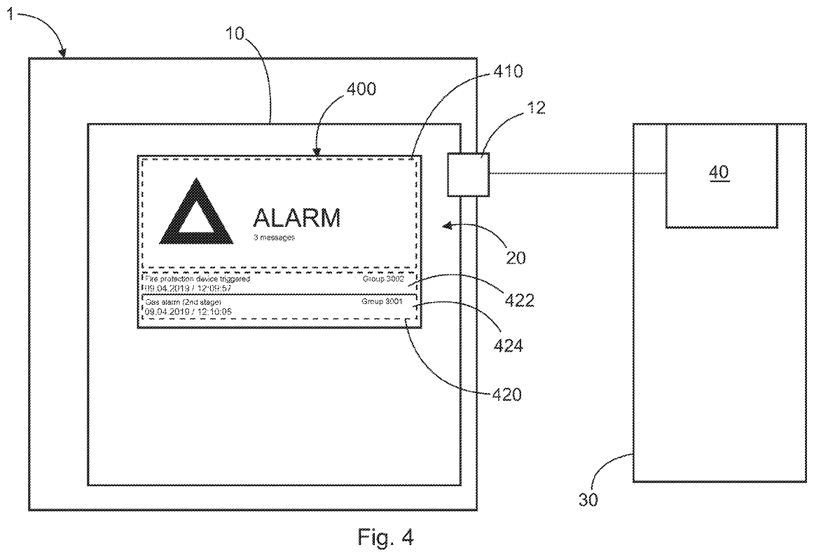

FIG. 4 shows the hazard alert system from FIG. 1 with a third event display 400. The display means 20 is configured here to present the third event display 400 which displays a third event, an alarm in the present case, in the main section 410. A latest message 424 and an oldest message 422 are displayed in the first edge section 420.

Alternatively, only the latest messages 224, 324 and 424 may also be displayed in the respective first edge section 220, 320, 420 of the first event display 200, of the second event display 300 and/or of the third event display 400.

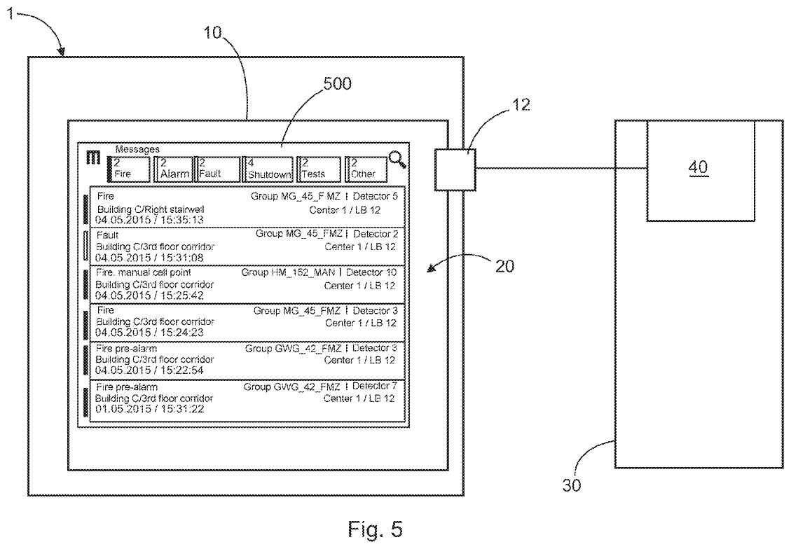

FIG. 5 shows the hazard alert system from FIG. 1 with a message presentation 500. The display means 20 of the control unit 10 here displays the message display 500. The message display 500 displays a plurality of messages in a manner filling the screen. The message display 500 can be called up by an operator, for example, if the operator taps on the main section 210, 310, 410 of the event displays 200, 300, 400. In addition, the message display 500 can be called up by an operator if the operator taps on the screen or on the display means 20 when the standard display 100 is displayed. The message display 500 displays a number of messages.

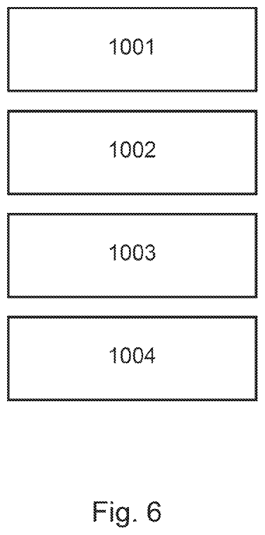

FIG. 6 shows a schematic method for operating a hazard alert center. In step 1001, the standard display 100 and/or the message display 500 is/are displayed by means of the display means 20, wherein an oldest message 222 and a latest message 224 are displayed and further messages can be displayed between the oldest message 222 and the latest message 224. It is preferred for the messages which are arranged between the oldest message 222 and the latest message 224 to be arranged in a scrollable manner. This means that it is possible to display a multiplicity of messages by means of a suitable scrolling means on the control unit 10. Alternatively, a standard display 100 can be displayed in step 1001.

In step 1002, a hazardous situation is detected, wherein this hazardous situation is preferably detected by a hazard detector 40. In addition, in step 1002, a first signal characterizing this hazardous situation is generated. This first signal is preferably generated by the hazard detector 40.

In step 1003, this first signal is received. It is preferred for the first signal to be received by the control unit 10. A coupling interface 12 may also be arranged between the control unit 10 and the hazard detector 40.

In step 1004, a first event is displayed in the first main section 210 of the display means 20, and the oldest message 222 and the latest message 224 are displayed in a first edge section 220.

The present invention makes it possible to reduce the response time in the case of events. The display of the first event display 200 in the main section 210 and the shifting of the messages 222, 224 into the first edge section 220 make it possible for the type of event to be immediately identified by an operator. The operator can therefore initiate the necessary steps in a considerably faster manner and can therefore avoid or at least reduce personal injury and/or material damage.

### LIST OF UTILIZED REFERENCE SIGNS

1 Hazard alert center
10 Control unit
12 Coupling interface
20 Display means
30 Monitoring region
40 Hazard detector
100 Standard display
200 First event display
210 Main section
220 First edge section
222 Oldest message
224 Latest message
230 Second edge section
232 First action means
234 Second action means
236 Third action means
300 Second event display
310 Main section
320 First edge section
322 Oldest message
324 Latest message
400 Third event display
410 Main section
420 First edge section
422 Latest message
500 Message display

1. A control unit for a hazard alert center, wherein the control unit
is configured to receive, from a hazard detector for detecting a hazardous situation, a first signal characterizing the hazardous situation,
comprises a user interface having a display means which is configured to present a standard display and/or a message display, wherein an oldest message and a latest message are displayed and further messages can be displayed between the oldest message and the latest message, and a first event display which displays a first event in a main section, wherein the oldest message and the latest message are displayed in a first edge section, and
is configured, upon receiving the first signal, to control the display means in such a manner that the first event display is displayed instead of the standard display and/or the message display.

2. The control unit as claimed in claim 1, wherein the user interface is in the form of a touch-sensitive input and output screen.

3. The control unit as claimed in claim 2, comprising a message actuation means, wherein, when the message actuation means is actuated, the display means is controlled by the control unit in such a manner that the message display is displayed instead of the first event display,
wherein the message actuation means is arranged on a main section of the input and output screen.

4. The control unit as claimed in claim 2, comprising
a first action means, wherein the control unit is configured to generate and transmit an alarm signal, in particular for alerting a fire department, when the first action means is actuated, and/or
a second action means, wherein the control unit is configured to extend a predetermined waiting time by a predetermined investigation time when the second action means is actuated, and/or
a third action means, wherein the control unit is configured to prevent an alarm signal from being generated and/or transmitted when the third action means is actuated.

5. The control unit as claimed in claim 4, wherein the first action means, the second action means and/or the third action means is/are arranged on a second edge section of the input and output screen.

6. The control unit as claimed in claim 1, wherein the control unit is configured to receive an all-clear signal and, upon receiving the all-clear signal, to control the display means in such a manner that the standard display and/or the message display is/are displayed instead of the first event display.

7. The control unit as claimed in claim 1, wherein the display means is configured to present a second event display, which displays a second event in the main section, and/or to present a third event display, which displays a third event in the main section, wherein the oldest message and the latest message are displayed in the first edge section, and the control unit is configured
to receive and/or generate a second signal characterizing a fault, and
upon receiving the second signal, to control the display means in such a manner that the second event display is displayed instead of the standard display and/or the message display, and/or
to receive and/or generate a third signal characterizing an alarm, and
upon receiving the third signal, to control the display means in such a manner that the third event display is displayed instead of the standard display and/or the message display.

8. The control unit as claimed in claim 1, wherein the oldest message and/or the latest message and/or the further messages have a bar-shaped presentation, wherein the bar-shaped presentation extends from a left-hand edge of the display means to a right-hand edge of the display means.

9. The control unit as claimed in claim 1, wherein the display means has a display region and the main section occupies more than 60% of the size of the display region.

10. The control unit as claimed in claim 9, wherein the first edge section is arranged in a lower section of the display region and adjoins a lower edge of the display region and occupies less than 30% of a height of the display region, and/or a second edge section is arranged in a left-hand section of the display region and adjoins a left-hand edge of the display region and occupies less than 30% of a width of the display region.

11. The control unit as claimed in claim 1, wherein the control unit is configured to display the standard display on the display means after a predefined inactivity time.

12. A hazard alert center comprising a control unit as claimed in claim 1.

13. A hazard alert system having a hazard alert center, the hazard alert system comprising: hazard detector for detecting a hazardous situation, a control unit which is coupled to the hazard detector using signaling and is configured to receive a first signal characterizing the hazardous situation from the hazard detector, wherein the control unit comprises a user interface having a display means, wherein the display means is configured to present:
a standard display and/or a message display, wherein an oldest message and a latest message are displayed and further messages can be displayed between the oldest message and the latest message in a scrollable manner, or
a first event display which displays a first event in a main section, wherein the oldest message and the latest message are displayed in a first edge section, wherein the control unit is configured, upon receiving the first signal, to control the display means in such a manner that the first event display is displayed instead of the standard display and/or the message display.

14. A method for operating a hazard alert center, comprising the steps of:
displaying a standard display and/or a message display by a display means, wherein an oldest message and a latest message are displayed and further messages can be displayed between the oldest message and the latest message;
detecting a hazardous situation and generating a first signal characterizing the hazardous situation;
receiving the first signal; and
displaying a first event in a main section of the display means and the oldest message and the latest message in a first edge section.
